(19) United States
(12) Patent Application Publication
(10) Pub. No.: US 2006/0259551 A1
(43) Pub. Date: Nov. 16, 2006

(54) DETECTION OF UNSOLICITED ELECTRONIC MESSAGES

(75) Inventor: Larry Thomas Caldwell JR., Annandale, VA (US)

Correspondence Address: W. Karl Renner;FISH & RICHARDSON P.C., P.O.BOX 1022, MINNEAPOLIS, MN, 55440-1022, US

(73) Assignee: Idalis Software, Annandale, VA (US)

(21) Appl. No.: 11/383,033

(22) Filed: May 12, 2006

Related U.S. Application Data
(60) Provisional application No. 60/679,931, filed on May 12, 2005.

(51) Int. Cl. G06F 15/16

(52) U.S. Cl. 709/204

(57) ABSTRACT

The detection of unsolicited electronic messages is provided for by searching for pre-formatted text indicative of point-of-contact information in the body of an electronic message. A plurality of electronic messages is received, including a first electronic message and a second electronic message, each electronic message including a header portion and a body portion. The body portion of the first electronic message is searched for pre-formatted text indicative of point-of-contact information, and at least a subset of the plurality of electronic messages, the subset including the second electronic message, is searched for the pre-formatted text. The second electronic message is identified as including the pre-formatted text based upon the searching of at least the subset of the plurality of electronic messages, and the first electronic message is flagged as unsolicited based at least upon the identifying of the second electronic message.

### CROSS-REFERENCE TO RELATED APPLICATIONS

This application claims the benefit of U.S. Provisional Patent Application No. 60/679,931, filed May 12, 2005, which is incorporated herein by reference.

### BACKGROUND

1. Field

This document generally relates to the detection of unsolicited electronic messages and, at least one particular implementation relates to detecting unsolicited electronic messages by searching for pre-formatted text indicative of point-of-contact information in the body of an electronic message.

2. Description Of The Related Art

Since the inception of networked computing, attempts have been made to exploit electronic messaging to solicit products or services to unwilling recipients. To this day, an alarming percentage of the estimated sixty billion electronic mail messages sent daily are bulk, unsolicited electronic mail messages, or ‘spam.’ Similar bulk unsolicited electronic messages, such as spam-over-instant messaging (“SPIN”) or web-log spam (“SPLOG”), account for an untold amount of additional network traffic, tying-up precious bandwidth and straining system resources. Typically, users and network administrators are fraught with the responsibility of detecting and deleting each unsolicited electronic message, with the overall costs of such efforts cutting into overhead and reducing the amount of time available for personnel to perform more productive activities. Despite advances made in automatic spam filtering technology, the problems caused by unsolicited electronic messages have only become worse over time.

Present spam filtering approaches, such as blocked-sender lists, Bayesian filters, safe lists, reverse domain name system (“DNS”) lookups, and challenge response techniques, are woefully inadequate, and are often several technological steps behind those who distribute unsolicited electronic messages, known as ‘spammers.’ Spammers can easily and effectively overcome a blocked-sender list, for example, by altering the origin data in the electronic message, by mailing unsolicited electronic messages from multiple message servers, or by redirected electronic messages off of computers, called ‘zombies,’ which have been implanted with a daemon which puts the computer under the control of the spammer. Bayesian filtering techniques, which have a basis in statistical analysis, are by design either over-conclusive, blocking desirable electronic mail messages, or under-conclusive, allowing unsolicited messages to be delivered. Thus, unsolicited electronic messages present a hydra-like challenge, which is effectively unmitigated by conventional detection and filtering techniques. Accordingly, it is desirable to provide for a new approach to the detection of unsolicited electronic messages which overcomes the deficiencies of these prior art detection technologies and approaches.

### BRIEF SUMMARY

According to a first arrangement, a method for detecting an unsolicited electronic message is provided. The method includes the steps of receiving a plurality of electronic messages, including a first electronic message and a second electronic message, each electronic message including a header portion and a body portion, searching the body portion of the first electronic message for pre-formatted text indicative of point-of-contact information, and searching at least a subset of the plurality of electronic messages, the subset including the second electronic message, for the pre-formatted text. The message also includes the steps of identifying the second electronic message as including the pre-formatted text based upon the searching of at least the subset of the plurality of electronic messages, and flagging the first electronic message as unsolicited based at least upon the identifying of the second electronic message.

With the knowledge that a majority of unsolicited electronic messages include this point-of-contact information, it is possible to search for the most common types of point-of-contact information via a corresponding pre-defined format. An electronic mail message, for example, is characterized by known sequences of alphanumeric characters such as “com” or “edu” and identifiable characters, such as the ‘at’ (“@”) character or repeated non-adjacent sequences ‘periods’ (“.”),in highly predictable locations within a string of characters. Pre-formatted text indicative of point-of-contact information is used as a basis to flag a message as an unsolicited electronic message, depending upon whether the pre-formatted text and/or the message meets or is distinguishable from various criteria or other messages bearing similar point-of-contact information. Accordingly, unsolicited electronic messages are discovered, cataloged, reviewed and/or deleted, and the delivery of similar unsolicited electronic messages is further prevented.

The first electronic message may be compared to the second electronic message, where flagging the first electronic message as unsolicited is also based upon the comparing of the first electronic message to the second electronic message. In one aspect, comparing the first electronic message and the second electronic message further includes comparing a size of the first electronic message with a size of the second electronic message, the first electronic message is flagged as unsolicited if a size of the first electronic message is within a predetermined threshold of a size of the second electronic message. In a second aspect, comparing the first electronic message and the second electronic message further includes comparing origin data from the header of the first electronic message with origin data from the header of the second electronic message, where the first electronic message is flagged as unsolicited if origin data from the header of the first electronic message is different than origin data from the header of the second electronic message.

The first electronic message may be subjected to a review, where flagging the first electronic message as unsolicited is also based upon the subjecting of the first electronic message to the review. Such a review may be manual and/or automated. In one aspect, subjecting the first electronic message to the review further includes comparing the pre-formatted text to an authorized database, where the electronic message is flagged as unsolicited if the pre-formatted text does not exist in the authorized database. In a second aspect, subjecting the first electronic message to the review further comprises comparing the pre-formatted text to an unauthorized database, where the electronic message is flagged as unsolicited if the pre-formatted text exists in the unauthorized database. The method may further include the steps of tokenizing the body portion of the first electronic message, and/or deleting the flagged first electronic message.

The electronic messages can be an electronic mail messages, text messages, or instant messages. The pre-formatted text can be a telephone number, an e-mail address, a uniform resource locator, an instant message address, a mailing address, or a stock symbol, where identifying the second electronic message is based upon the pre-formatted text existing in the body of the second electronic message.

Searching the body portion of the first electronic message for pre-formatted text indicative of point-of-contact information may further include looking for a data matching pattern recognized as billing contact pattern. Searching at least the subset of the plurality of electronic messages for the pre-formatted text may further include looking at the plurality of electronic messages, except for the first electronic message, for the data matching pattern recognized as the billing contact pattern found in the first electronic message. Identifying the second electronic message as including the pre-formatted text based upon the searching of at least the subset of the plurality of electronic messages may further include designating the second electronic message as containing the data matching pattern recognized as the billing contact pattern based upon finding the data matching pattern in the second electronic message.

According to a second arrangement, a device for detecting an unsolicited electronic message is provided. The device includes a receiver module configured to receive a plurality of electronic messages, including a first electronic message and a second electronic message, each electronic message including a header portion and a body portion. The device also includes a search module configured to search the body portion of the first electronic message for pre-formatted text indicative of point-of-contact information, search at least a subset of the plurality of electronic messages, the subset including the second electronic message, for the pre-formatted text, and further configured to identify the second electronic message as including the pre-formatted text based upon the searching of at least the subset of the plurality of electronic messages. Furthermore, the device includes an indicator module configured to flag the first electronic message as unsolicited based at least upon the identifying of the second electronic message.

A comparison module may be configured to compare the first electronic message to the second electronic message, where the indicator module is configured to flag the first electronic message as unsolicited also based upon the comparing of the first electronic message to the second electronic message. In one aspect, the comparison module compares a size of the first electronic message with a size of the second electronic message, where the indicator module is configured to flag the first electronic message as unsolicited if a size of the first electronic message is within a predetermined threshold of a size of the second electronic message. In a second aspect, the comparison module compares origin data from the header of the first electronic message with origin data from the header of the second electronic message, where the indicator module is configured to flag the first electronic message as unsolicited if origin data from the header of the first electronic message is different than origin data from the header of the second electronic message.

A review module may be configured to subject the first electronic message to a review, where the indicator module is configured to flag the first electronic message as unsolicited also based upon the subjecting of the first electronic message to the review. In one aspect, the review module is configured to compare the pre-formatted text to the authorized database, the indicator module is configured to flag the electronic message as unsolicited if the pre-formatted text does not exist in the authorized database. In a second aspect, the review module is configured to compare the pre-formatted text to the unauthorized database, where the indicator module is configured to flag the electronic message as unsolicited if the pre-formatted text exists in the unauthorized database.

According to a third arrangement, a system is provided for detecting an unsolicited electronic message. The system includes a central database server and a message server. The central database server further includes a central database receiver module configured to receive a first electronic message, a manual review module configured to manually review the first electronic message, a central database indicator module configured to generate the delete signal and an unauthorized database based upon the manual review of the first electronic message, and a central database transmitter module configured to transmit the delete signal and the unauthorized database. The message server further includes a message server receiver module configured to receive the unauthorized database, the delete signal, and a plurality of electronic messages, including the first electronic message and a second electronic message, each electronic message including a header portion and a body portion, a tokenizer module configured to tokenize the body portion of the first electronic message, and a search module configured to search the body portion of the first electronic message for pre-formatted text indicative of point-of-contact information, search at least a subset of the plurality of electronic messages, the subset including the second electronic message, for the pre-formatted text, and further configured to identify the second electronic message as including the pre-formatted text based upon the searching of at least the subset of the plurality of electronic messages and finding the pre-formatted text in the body of the second electronic message. The message server also includes a comparison module configured to compare the first electronic message to the second electronic message, an automated review module configured compare the pre-formatted text to the unauthorized database, a message server indicator module configured to flag the first electronic message as unsolicited based at least upon the identifying of the second electronic message, upon the comparing of the first electronic message to the second electronic message, upon the comparing the pre-formatted text to the unauthorized database, and/or upon receiving the delete signal, and a message server transmitter module configured to transmit the first electronic message to the central database server.

According to a fourth arrangement, a computer program product, tangibly stored on a computer-readable medium, is provided for detecting an unsolicited electronic message. The product includes instructions for permitting a computer to perform a receiving step for receiving a plurality of electronic messages, including a first electronic message and a second electronic message, each electronic message including a header portion and a body portion, and a first searching step for searching the body portion of the first electronic message for pre-formatted text indicative of point-of-contact information. The product also includes instructions for permitting a computer to perform a second searching step for searching at least a subset of the plurality of electronic messages, the subset including the second electronic message, for the pre-formatted text, an identifying step for identifying the second electronic message as including the pre-formatted text based upon the searching of at least the subset of the plurality of electronic messages, and a flagging step for flagging the first electronic message as unsolicited based at least upon the identifying of the second electronic message.

According to a fifth arrangement, a method for detecting an unsolicited electronic message is provided. The method includes the steps of receiving a plurality of electronic messages, including a first electronic message and a second electronic message, each electronic message including a header portion and a body portion, tokenizing the body portion of the first electronic message, and searching the body portion of the first electronic message for pre-formatted text indicative of point-of-contact information. The method also includes the steps of searching at least a subset of the plurality of electronic messages, the subset including the second electronic message, for the pre-formatted text at the message server, identifying the second electronic message as including the pre-formatted text based upon the searching of at least the subset of the plurality of electronic messages, and comparing the first electronic message to the second electronic message. The method additional includes the steps of comparing the pre-formatted text to an unauthorized database, and subjecting the first electronic message to a manual review. Furthermore, the method includes the steps of generating a delete signal and the unauthorized database based upon the manual review; and flagging the first electronic message as unsolicited based at least upon the identifying of the second electronic message, the comparing of the first electronic message to the second electronic message, the comparing of the pre-formatted text to the unauthorized database, and/or the generating of the delete signal.

This brief summary has been provided to enable a quick understanding of various concepts and implementations described by this document. A more complete understanding can be obtained by reference to the following detailed description in connection with the attached drawings. It is to be understood that other implementations may be utilized and changes may be made.

### BRIEF DESCRIPTION OF THE DRAWINGS

Referring now to the drawings, in which like reference numbers represent corresponding parts throughout:

FIG. 1 depicts the exterior appearance of a message server according to one example arrangement;

FIG. 2 depicts an example of an internal architecture of the FIG. 1 arrangement;

FIG. 3 is a block diagram illustrating the flow of data between a local message server, a central database server, a user workstation, and a message server used by the sender of the unsolicited message, via a network, according to one example architecture; and

FIG. 4 is a flowchart illustrating an example method for detecting an unsolicited electronic method, according to one arrangement.

### DETAILED DESCRIPTION

As recited herein, in one implementation, the detection of unsolicited electronic messages is accomplished by eliminating the stream of revenue which unsolicited electronic messages provide to spammers, thereby reducing the motivation for spammers to distribute bulk electronic messages in the first place. It has been determined that nearly all unsolicited electronic messages are sent for the purpose of generating revenue, and that the primary vehicle for generating revenue via unsolicited electronic message is the proffering of products or services. There is thus a high probability that each unsolicited electronic message provides point-of-contact information for a recipient to make contact with the spammer to provide payment or receive additional information, such as via a telephone number or an electronic mail address.

With the knowledge that a majority of unsolicited electronic messages include this point-of-contact information, it is possible to search for the most common types of point-of-contact information via the format of the point-of-contact information. An electronic mail message, for example, is characterized by known sequences of alphanumeric characters, such as “corn” or “edu,” and identifiable characters, such as the ‘at’ (“@”) character or repeated non-adjacent sequences ‘periods’ (“.”),in highly predictable locations within a string of characters. Pre-formatted text indicative of point-of-contact information is used as a basis to flag a message as an unsolicited electronic message, depending upon whether the pre-formatted text and/or the message meets various criteria or is distinguishable from other messages bearing similar point-of-contact information.

Accordingly, multiple instances of a single electronic message are detected using static references of pre-formatted text indicative of point-of-contact information to determine the number of instances within a batch of accumulated but as-yet-unprocessed electronic messages, and also to use the static references for deleting, blocking, tracing, and/or safe-listing of the static references, depending upon the underlying nature of the particular electronic message. Additionally, measurable statistics of electronic message usage can be provided and used to filter those electronic messages with legitimate origin data or mailing list removal instructions, for example, to allow a mail server administrator to block malicious bulk senders or to collect data on behalf of governmental agencies. More specifically, each unsolicited electronic message blast is tracked based upon a unique characteristic, such as a point-of-contact information, where an accounting can be performed on that unique characteristic by collecting data off of multiple mail servers. This data is then used to identify the sender of the blast, and to track the number of messages sent, the level of randomness to each electronic message, the types of recipients, and the illegality of the content of the electronic message. The tracking data is forwarded to anti-spam corporations or government agencies for use in criminal prosecution, or to improve next-generation spam filters.

In this regard, electronic messages, particularly electronic messages composed in a readable format or readable attachments, are scanned during any part of the delivery process occurring on an external or internal network. Static or non-changing characteristics within an electronic message, such as a website uniform resource locator (“URL”), and/or origin data such as a sender address, a subject, attachment name, size or a pre-defined word are detected. If multiple instances of these static characteristics are found, a central database server is used to provide a review of each electronic message, where the results of the review are used to update mail servers with an authorized database and/or an unauthorized database, in order to block or allow specified mail servers from delivering bulk, unsolicited electronic messages. By eliminating the source of revenue for spammers in real-time or near real-time, the underlying motivation for sending the unsolicited electronic message is eliminated, reducing the overall number of illegitimate messages sent.

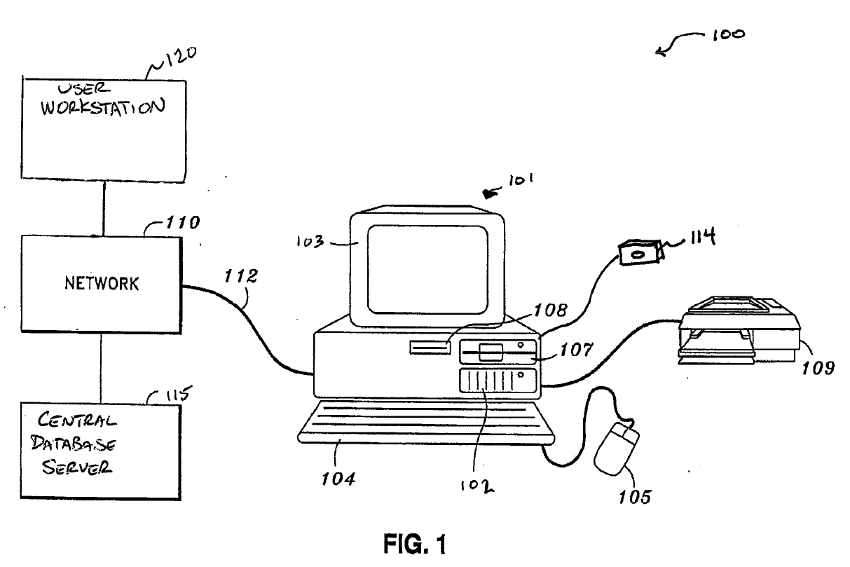

FIG. 1 depicts the exterior appearance of a system for detecting an unsolicited electronic message according to one example arrangement. System 100 includes message server 101, which in turn includes a computer-readable storage medium, such as fixed disk drive 102, in which is stored a program for detecting an unsolicited electronic message. As shown in FIG. 1, the hardware environment of mail server 100 includes message server 101, display monitor 103 for displaying text and images to a user, keyboard 104 for entering text data and user commands into message server 101, mouse 105 for pointing, selecting and manipulating objects displayed on display monitor 103, fixed disk drive 102, removable disk drive 107, tape drive 108, hardcopy output device 109, computer network 110, computer network connection 112, and digital input device 114.

Display monitor 103 displays the graphics, images, and text that comprise the user interface for the software applications used by this arrangement, as well as the operating system programs necessary to operate message server 101. A user of message server 101 uses keyboard 104 to enter commands and data to operate and control the computer operating system programs as well as the application programs. The user operates mouse 105 to select and manipulate graphics and text objects displayed on display monitor 103 as part of the interaction with and control of message server 101 and applications running on message server 101. Mouse 105 is, for example, any type of pointing device, including a joystick, a trackball, or a touch-pad. Furthermore, digital input device 114 allows message server 101 to capture digital images, and is typically a scanner, digital camera or digital video camera.

The unsolicited electronic message detection applications and data structures are stored locally on computer readable memory media, such as fixed disk drive 102. In a further aspect, fixed disk drive 102 itself includes a number of physical drive units, such as a redundant array of independent disks (“RAID”). In a further additional aspect, fixed disk drive 102 is a disk drive farm or a disk array that is physically located in a separate computing unit. Such computer readable memory media allow message server 101 to access image data, sequence data, user interface data, assessment data, organization data, administrative data, timing data, mastery data, score data, comment data, or other types of data, computer-executable process steps, application programs and the like, stored on removable and non-removable memory media.

Network connection 112 is typically a modem connection, a local-area network (“LAN”) connection including the Ethernet, or a broadband wide-area network (“WAN”) connection such as a digital subscriber line (“DSL”), cable high-speed internet connection, dial-up connection, T-1 line, T-3 line, fiber optic connection, or satellite connection. Network 110 is typically a LAN network, however, in further aspects, network 110 is a corporate or government WAN network, or the Internet.

Removable disk drive 107 is a removable storage device that is used to off-load data from message server 101 or upload data onto message server 101. Removable disk drive 107 is typically a floppy disk drive, an IOMEGA® ZIP® drive, a compact disk-read only memory (“CD-ROM”) drive, a CD-Recordable drive (“CD-R”), a CD-Rewritable drive (“CD-RW”), a DVD-ROM drive, flash memory, a Universal Serial Bus (“USB”) flash drive, thumb drive, pen drive, key drive, or any one of the various recordable or rewritable digital versatile disk (“DVD”) drives such as the DVD-Recordable (“DVD-R” or “DVD+R”), DVD-Rewritable (“DVD-RW” or “DVD+RW”), or DVD-RAM. Operating system programs, applications, and various data files, such as image data, sequence data, user interface data, assessment data, organization data, administrative data, timing data, or comment data application programs, are stored on disks. The files are stored on fixed disk drive 102 or on removable media for removable disk drive 107 without departing from the scope of the present invention.

Tape drive 108 is a tape storage device that is used to off-load data from message server 101 or upload data onto message server 101. Tape drive 108 is typically a quarter-inch cartridge (“QIC”), 4 mm digital audio tape (“DAT”), or 8 mm digital linear tape (“DLT”) drive.

Hardcopy output device 109 provides an output function for the operating system programs and applications including applications for detecting unsolicited electronic messages. Hardcopy output device 109 is typically a printer or any output device that produces tangible output objects, including textual or image data or graphical representations of textual or image data. While hardcopy output device 109 is generally connected directly to message server 101, it need not be. For instance, in an alternate arrangement of the invention, hardcopy output device 109 is connected via a network interface (e.g., wired or wireless network, not shown).

Although message server 101 is illustrated in FIG. 1 as a desktop PC, in further aspects, message server 101 is a laptop, a workstation, a midrange computer, a mainframe, or an embedded system. Central database server 115 and user workstation 120, to which the electronic messages are ultimately intended to be delivered, each include components with features, functions and structures similar to corresponding components of message server 101, described above, and further description of each system is therefore omitted for the sake of brevity. In alternate aspects, the functions of central database server 115 and/or user workstation 120 are combined with each other or with message server 101, or are omitted altogether, such as the case where the functions or structure of the central database server 115 are integrated with user workstation 120 and/or message server 101, or where the functions or structure of message server 101 are integrated with user workstation 120. Each of these aspects, and others, are contemplated by this arrangement.

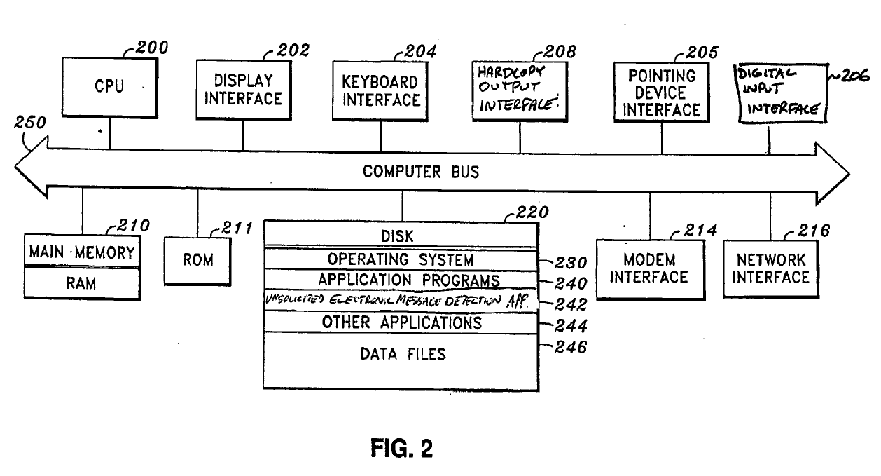

FIG. 2 depicts an example of an internal architecture of the FIG. 1 arrangement. The computing environment includes computer central processing unit (“CPU”) 200 where the computer instructions that include an operating system or an application, including the unsolicited electronic message detection applications, are processed; display interface 202 which provides a communication interface and processing functions for rendering graphics, images, and texts on display monitor 103; keyboard interface 204 which provides a communication interface to keyboard 104; pointing device interface 205 which provides a communication interface to mouse 105 or an equivalent pointing device; digital input interface 206 which provides a communication interface to digital input device 114; hardcopy output device interface 208 which provides a communication interface to hardcopy output device 109; random access memory (“RAM”) 210 where computer instructions and data are stored in a volatile memory device for processing by computer CPU 200; read-only memory (“ROM”) 211 where invariant low-level systems code or data for basic system functions such as basic input and output (“I/O”), startup, or reception of keystrokes from keyboard 104 are stored in a non-volatile memory device; disk 220 which can comprise fixed disk drive 102 and removable disk drive 107, where the files that comprise operating system 230, application programs 240 (including unsolicited electronic message detection application 242 and other applications 244) and data files 246 are stored; network interface 214 which provides a communication interface to computer network 110 over a modem; and computer network interface 216 which provides a communication interface to computer network 110 over a computer network connection 112. The constituent devices and computer CPU 200 communicate with each other over computer bus 250.

RAM 210 interfaces with computer bus 250 so as to provide quick RAM storage to computer CPU 200 during the execution of software programs such as the operating system application programs, and device drivers. More specifically, computer CPU 200 loads computer-executable process steps from fixed disk drive 102 or other memory media into a field of RAM 210 in order to execute software programs. Data, including image data, sequence data, interface data, assessment data, organization data, administrative data, timing data, score data, comment data or other data relating to unsolicited electronic message detection, is stored in RAM 210, where the data is accessed by computer CPU 200 during execution.

Also shown in FIG. 2, disk 220 stores computer-executable code for a windowing operating system 230, application programs 240 such as word processing, spreadsheet, presentation, graphics, gaming, or other applications. Disk 220 also stores the detection applications 242 which provide for the detection of unsolicited electronic messages.

Although it is possible to provide for the detection of unsolicited electronic messages using the above-described implementation, it is also possible to implement this functionality through the use of a dynamic link library (“DLL”), or a plug-in to other application programs such as an Internet web-browser such as the MICROSOFT® Internet Explorer web browser.

Computer CPU 200 is one of a number of high-performance computer processors, including an INTEL® or AMD® processor, a POWERPC® processor, a MIPS® reduced instruction set computer (“RISC”) processor, a SPARC® processor, a HP ALPHASERVER® processor or a proprietary computer processor for a mainframe. In an additional arrangement, computer CPU 200 in message server 101 is more than one processing unit, including a multiple CPU configuration found in high-performance workstations and servers, or a multiple scalable processing unit found in mainframes.

Operating system 230 is typically any of MICROSOFT® WINDOWS NT®/WINDOWS® 2000/WINDOWS® XP Workstation; WINDOWS NT®/WINDOWS® 2000/WINDOWS® XP Server; a variety of UNIX®-flavored operating systems, including AIX® for IBM® workstations and servers, SUNOS® for SUN® workstations and servers, LINUX® for INTEL® CPU-based workstations and servers, HP UX WORKLOAD MANAGER® for HP® workstations and servers, IRIX® for SGI® workstations and servers, VAX/VMS for Digital Equipment Corporation computers, OPENVMS® for HP ALPHASERVER®-based computers, MAC OS® X for POWERPC® based workstations and servers; or a proprietary operating system for mainframe computers.

While FIGS. 1 and 2 illustrate one possible arrangement a computing system that executes program code, or program or process steps, configured to provide image interpretation to a user, other types of computers or mail servers are also be used as well.

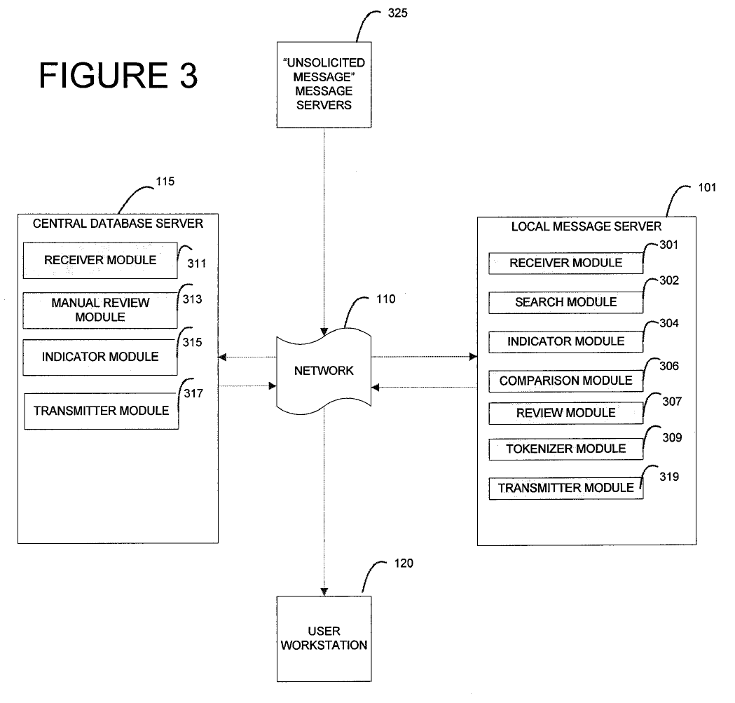

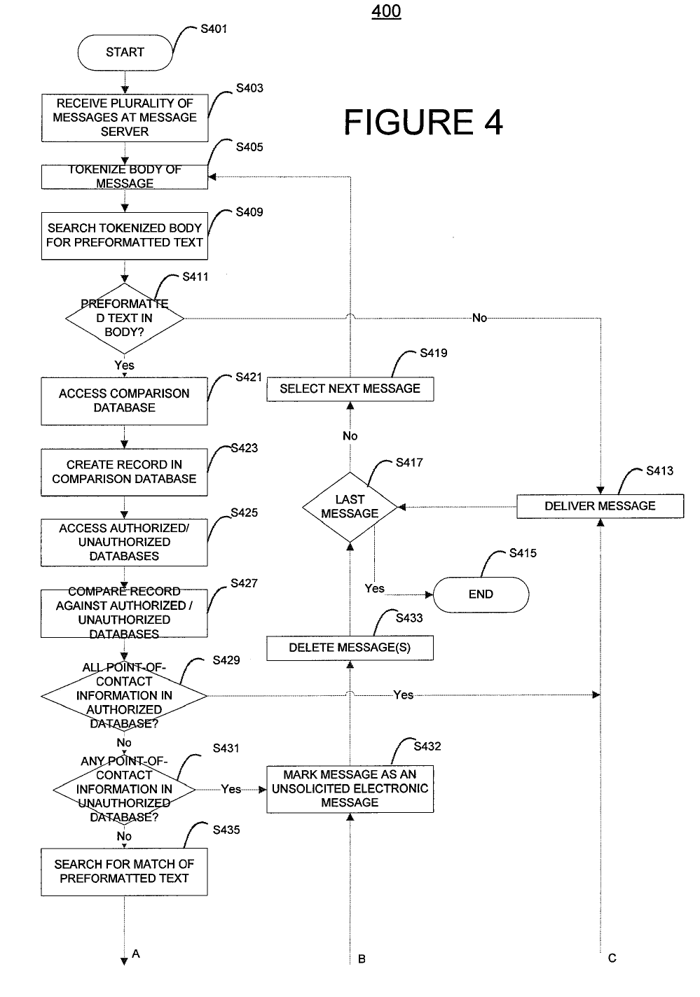

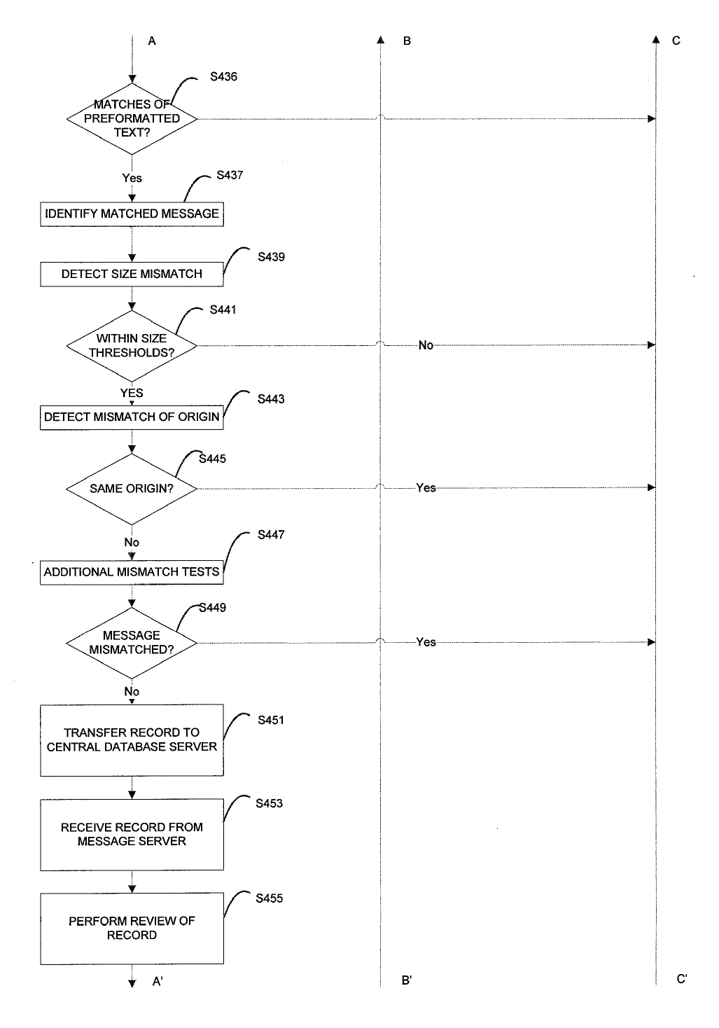

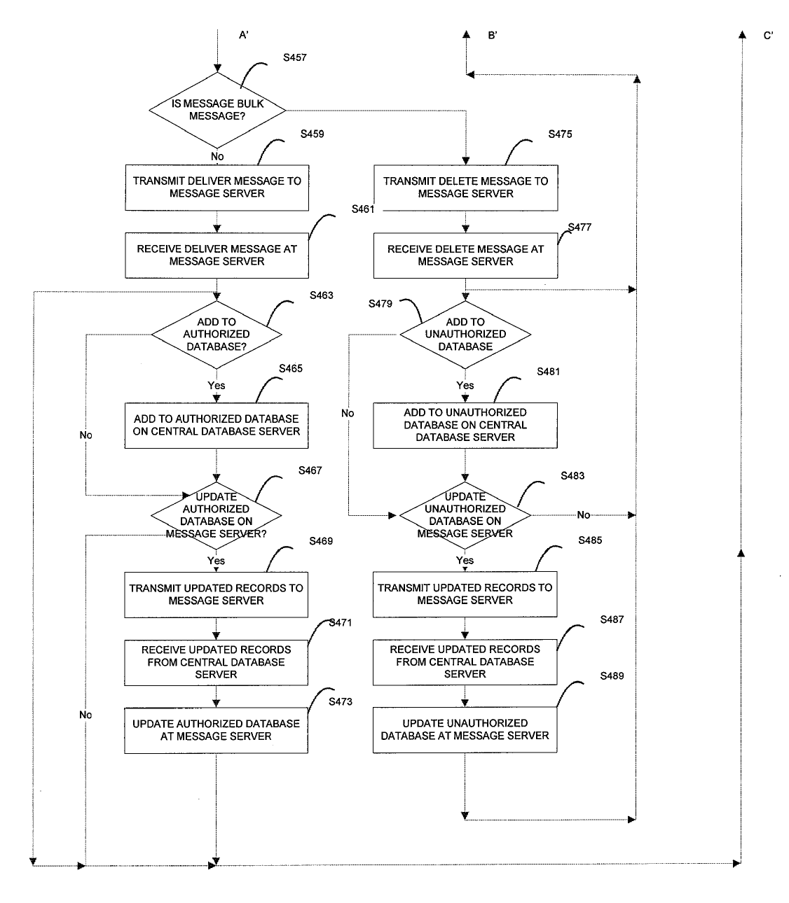

FIG. 3 is a block diagram of a system for detecting an unsolicited electronic message, illustrating the flow of data between local message server 101, central database server 115, user workstation 120, and message server 325 used by the sender of the unsolicited message, according to one example architecture. Briefly, and as described more fully below with reference to FIG. 4, message server 101 includes receiver module 301 configured to receive a plurality of electronic messages, including a first electronic message and a second electronic message, each electronic message including a header portion and a body portion. Message server 101 also includes search module 302 configured to search the body portion of the first electronic message for pre-formatted text indicative of point-of-contact information, search at least a subset of the plurality of electronic messages, the subset including the second electronic message, for the pre-formatted text, and further configured to identify the second electronic message as including the pre-formatted text based upon the searching of at least the subset of the plurality of electronic messages. Additionally, message server 101 includes indicator module 304 configured to flag the first electronic message as unsolicited based at least upon the identifying of the second electronic message.

Comparison module 306, which may be included in message server 101, is configured to compare the first electronic message to the second electronic message, where the indicator module is configured to flag the first electronic message as unsolicited also based upon the comparing of the first electronic message to the second electronic message. Review module 307 may be configured to subject the first electronic message to a review, where the indicator module 308 is configured to flag the first electronic message as unsolicited also based upon the subjecting of the first electronic message to the review. Finally, tokenizer module 309 may be configured to tokenize the body portion of the first electronic message. While each of modules 301 to 319 are shown as discrete modules, it is understood that each of the modules may be omitted or combined, as necessary or desired.

Central database server 115 further includes central database receiver module 311 configured to receive a first electronic message, manual review module 313 configured to manually review the first electronic message, central database indicator module 315 configured to generate the delete signal and an unauthorized database based upon the manual review of the first electronic message, and central database transmitter module 317 configured to transmit the delete signal and the unauthorized database. Local message server 101 also includes a message server transmitter module 319 configured to transmit the first electronic message to the central database server.

As shown in FIG. 3, unsolicited electronic messages originate from ‘unsolicited message’ message servers 325. The unsolicited message travels via network 110 and reaches local message server 101. As indicated above, although network 110 is described and illustrated as one network for the sake of brevity, it is contemplated that network 110 includes several networks, including the Internet and various intranets, and combinations thereof. Furthermore, although FIG. 3 illustrates that ‘unsolicited message’ message servers 325, local message server 101, user workstation 120 and central database server 115 communicate via network 110, it is also contemplated that communication occurs between the various constituent devices on different networks, such as the case where ‘unsolicited message’ message servers 325 transmit an unsolicited electronic message to local message server 101 via the Internet, and local message server 101 communicates with central database server 115 and/or user workstation 120 via an intranet or via internal communication within a single device.

As described in more detail with respect to FIG. 4, processing on the unsolicited electronic message occurs partially on local message server 101, and partially on central database server 115 where the unsolicited electronic message and/or data relating to the unsolicited electronic message are passed from local message server 101 to and from central database server 115 either directly or through a network such as network 110. In other arrangements, local message server 101 and central database server 115 are unified in one device or locality, and no external communication is therefore required. Once an electronic message has been adjudged as not unsolicited, it is transmitted from local message server 101 to user workstation 120, either directly or via a network, such as network 110.

FIG. 4 is a flowchart illustrating a method for detecting an unsolicited electronic message. Briefly, and amongst other steps, the method includes receiving a plurality of electronic messages, including a first electronic message and a second electronic message, each electronic message including a header portion and a body portion, searching the body portion of the first electronic message for pre-formatted text indicative of point-of-contact information, and searching at least a subset of the plurality of second electronic message for the pre-formatted text. The message also includes the steps of identifying the second electronic message as including the pre-formatted text based upon results achieved when searching at least the plurality of electronic messages, and flagging the first electronic message as unsolicited based at least upon the identifying of the second electronic message.

In more detail, the process begins (step S401), and a plurality of electronic messages, including a first electronic message and a second electronic message, are received, each electronic message including a header portion and a body portion (step S403). With regard to electronic messaging, a header is typically the first part of an electronic message containing controlling meta-data such as the subject, origin and destination electronic message addresses, the path an electronic message takes, and/or the electronic message priority. The header also may contain information about the electronic message client and, as the electronic message travels to its destination, information about the path it took is often appended to the header. As defined by Research For Comments (“RFC”) 2822 et seq., the header includes the fields applied to each particular message, including a summary, sender, receiver, sender and sending server computer IP or DNS address, ‘from:’ field, ‘to’: field, ‘subject:’ field, ‘date:’ field, and ‘received:’ field data.

The body of the electronic message, on the other hand, contains the substance of the message to be delivered, and may be as simple as American Standard Code for Information Interchange (“ASCII”) text, or as complex as computer-readable code with embedded graphics or sound files, and/or attached files, where attached messages are considered elements of the body of the electronic message. Accordingly, the body includes the encoded text and associated file attachment which the user views upon opening an electronic message. Common body formats include 7 or 8 bit ASCII, Multipurpose Internet Mail Extensions (“MIME”), base64 binary-to-text encoding, or 8BITMIME.

Many types of electronic messages exist, including electronic mail messages, text messages, instant messages, although other types of messages exist which may also benefit from the application of this method. For example, electronic versions of paper-based or oral messages, which may have been digitized via speech recognition or optical character recognition (“OCR”) are also considered electronic messages.

In the FIG. 3 arrangement, for example, local message server 101 receives electronic solicited and unsolicited messages from message servers, such as ‘unsolicited message’ message servers 325, via network 110, where the messages are received by local message server 101 individually or in a group. By design or by chance, these received electronic messages accumulate in receiver module 301 while awaiting processing to determine whether the received electronic messages are unsolicited. Once received, the plurality of electronic messages are often referred to as a ‘batch’ of unprocessed electronic messages.

It is often the case that a bulk sender of unsolicited electronic messages will send electronic messages in a ‘blast,’ in which a large number of unsolicited electronic messages are sent in a short period of time. By allowing a plurality of electronic messages to accumulate prior to further processing, it is more likely that multiple electronic messages of a single blast will be received and processed together, increasing the probability that similar unsolicited electronic messages will be detected and automatically filtered, reducing cost and increasing available system bandwidth.

Prior to or in conjunction with batch processing, other unsolicited electronic message detection techniques may be applied to the messages, either individually or as a group. For example, and according to one aspect, the header portion of each incoming electronic message is checked against a blocked-sender list, and/or a Bayesian filter is applied against each electronic message. In another aspect, no other unsolicited electronic message detection techniques other than those techniques described below are applied.

The body of the first electronic message is tokenized (step S405). Tokenizing is an operation in which the string of characters which comprise the body of the first electronic message is split into categorized blocks of text, such as blocks of pre-formatted text indicative of point-of-contact information. While tokenizing can increase the speed and efficiency of unsolicited electronic message detection, in alternate aspects tokenizing is omitted. Tokenizing is omitted, for example, where it is desirable to reduce computational expense, or where the substance of incoming electronic messages render tokenizing unnecessary. As indicated above, each attached file associated with the electronic message is also tokenized, since the attached files are considered as part of the body of the electronic message. In one aspect, body text which is not pre-formatted text indicative of point-of-contact information is ignored or discarded.

The body portion of the first electronic message is searched for pre-formatted text indicative of point-of-contact information (step S409). A string of characters which are arranged in a specified, known, or pre-arranged form is an example of pre-formatted text. While the data identified by pre-formatted text may change, the format or layout of each type of pre-formatted text should remain the same. Common types of pre-formatted text indicative of point-of-contact information include, for example, a telephone number, an e-mail address, a uniform resource locator, an instant message address, a mailing address, or a stock symbol. In the case of a telephone number in the United States, for example, the text would typically be pre-formatted according to the formula “(###)###-####”, where each “#” represents a numeric character. It is also contemplated that pre-formatted text for telephone numbers of different localities would be searched, as well as common variation used to render a telephone number, such as “###.###.####”, “1-###-###-####”, “###-####”, or alphabetical character substitutions for numeric characters.

Another type of pre-formatted text indicative of point-of-contact information is an electronic mail address, which is typically pre-formatted according to the formula “NAME@DOMAIN.COM”, where NAME represents the user name, DOMAIN.COM represents the user's domain. Due to pervasive data mining of electronic mail addresses on computer network, it is typical that an electronic mail address or other pre-formatted text indicative of point-of-contact information are intentionally randomized, such as by changing the example electronic mail address to “NAME (AT) DOMAIN.COM” or “NAME@DOMAIN.COM”. During the tokenizing process (step S405), common disguises or spoofs of point-of-contact information are removed, so that the undisguised point-of-contact information may be used to detect whether the electronic message is unsolicited, using hash-busting algorithms. Hash-busting algorithms eliminate random words inserted into the electronic messages which are used to overcome probability-based filters. Furthermore, hash-busting algorithms improve the efficiency of the methods described herein, allowing better comparisons between messages of a single unsolicited electronic message blast, and improving overall detection performance. Even when the point-of-contact information is disguised, the electronic message is still seen to include pre-formatted point-of-contact information, since tokenizing replaces the disguised information with an undisguised version of the pre-formatted information.

As discussed supra, it is recognized that a nearly all unsolicited electronic messages are sent for the purpose of generating revenue, and that the primary vehicle for generating revenue via unsolicited electronic message is by proffering product or services for sale. In this regard, point-of-contact information can be used to identify whether an electronic message is unsolicited, using an extrinsic and/or intrinsic analysis of the electronic message. More specifically, searching the body portion of the first electronic message for pre-formatted text indicative of point-of-contact information further includes looking for a data matching pattern recognized as billing contact pattern.

The pre-formatted text indicative of point-of-contact information is not required to be information which leads back to the sender of the electronic message, such as the case where the electronic message contains a computer virus or a stock symbol. With regard to stock symbols, crafty individuals will often purchase stocks, and send electronic message blasts describing the benefits of owning the stock, on the hopes that recipients will also purchase the stock and artificially inflating the value. In addition to being a nuisance, these electronic messages are also illegal in many jurisdictions. In this case, the pre-formatted text indicative of point-of-contact information is the company name or stock ticker symbol, which is a five-character string according to many stock exchanges in the United States.

If, at step S411, pre-formatted text indicative of point-of-contact information does not exist in the body of the first electronic message, the first electronic message is delivered (step S413). Since revenue-generating unsolicited electronic messages often include point-of-contact information to enable a recipient to contact a spammer, the lack any pre-formatted text within an message is a robust indicator (although not necessarily conclusive) that the electronic message is not, in fact, unsolicited. These types of electronic messages are delivered, such as by transmitting the first electronic message to an inbox application on a user workstation, or by sending a trigger, such as a deliver message, to another module or entity to trigger or otherwise enable delivery of the electronic message. In any regard, other conventional anti-spam techniques can be applied to the electronic messages under scrutiny at this or any other step in method 400, thereby reducing the number of messages which require manual scrutiny.

If the first electronic message is the last message (step S417), the process ends (step S415) until a new batch of two or more electronic messages is received. A batch of electronic messages can comprise any number of electronic messages greater than two, including three electronic messages, ten thousand electronic messages, or several million electronic messages. Although the accuracy of the determination is seen to increase as the number of electronic messages in the batch increases, overall speed and resource scheduling issues are benefited by smaller batches.

If the first electronic message is not the last message (step S417), the next electronic message is selected (step S419), and processing of the next message occurs in the same manner as the first electronic message (step S405 et seq.).

If pre-formatted text indicative of point-of-contact information exists in the body of the first electronic message (step S411), a comparison database is accessed (step S421). It is envisioned that the comparison database is a structured query language (“SQL”) database existing on the message server, although other query languages could also be used, and/or the comparison database could exist on another entity such as the central database server or the user workstation.

A record is created in the comparison database, the record including at least a copy of the first electronic message, and the point-of-contact information described by the pre-formatted text (step S423). A record in the comparison database is created for each message which includes pre-formatted text indicative of point-of-contact information. Each record includes at least a field for the pre-formatted text, and a copy of or a link to the body of the message under scrutiny, although other fields such as received time or date field, a unique identifier field, sender address, sending computer, sending server, message size, attachment name, attachment sizes, attachment file types, a copy of the whole message file object, or other fields are also contemplated.

An authorized database and/or an unauthorized database are accessed (step S425). Although the creation of the authorized database and/or the unauthorized database is described in detail infra (steps S463 and S479), it suffices at this point to say that, in an arrangement where the central database server and the mail server are separate entities, the central database server creates the authorized database and/or the unauthorized database, and transmits each database and/or updated records for each database to the mail server. The authorized database includes a list of point-of-contact information that is associated with a prima facie authorized electronic message sender, while the unauthorized database includes a list of point-of-contact information that is associated with a prima facie unauthorized electronic message sender.

A prima facie authorized message, for example, is a message which is assumed to not be unsolicited, based upon all of the pre-formatted text contained therein being indicative of points-of-contact which have been previously adjudged as legitimate. The advantage of the authorized database is that a message which is seen to contain only pre-formatted text existing in the authorized database is not required to undergo further legitimacy testing. For example, if the website “www.idalissoftware.com” has been placed in the authorized database, and the only pre-formatted text within the electronic message is the string “www.idalissoftware.com,” then the message is assumed to not be an unsolicited message and is delivered without undergoing further legitimacy testing.

Conversely, prima facie unauthorized message is a message which is assumed to be unsolicited, based upon at least one of the pre-formatted text strings contained therein being indicative of a point-of-contact which has previously been adjudged as an originator of unsolicited electronic messages. The advantage of having an unauthorized database is that computational expense is not wasted on performing further legitimacy testing on a message which contains pre-formatted text existing in the unauthorized database. For example, if the website “www.viagraforsale.com” has been placed in the unauthorized database, then the message is assumed to be unsolicited, and is deleted without requiring further legitimacy testing.

The record is compared against the authorized database and/or the unauthorized database (step S427). Comparing the record against each database subjects the first electronic message to a review, where the determination of whether the first electronic message is unsolicited is based in part upon the outcome of this review.

If all of the pre-formatted text contained in the record for the first electronic message exist in the authorized database (step S429), the first electronic message is delivered (step S413), and ‘next message’ processing occurs (step S417 et seq.). As indicated above, a record of the pre-formatted text in the authorized database provides prima facie evidence that the electronic message is not unsolicited. In essence, pre-formatted text which exists in the authorized database is ignored.

If the pre-formatted text does not exist in the authorized database, further tests may be performed to determine if the first electronic message is unsolicited. For instance, the existence of pre-formatted text within the unauthorized database provides prima facie evidence that an electronic message is unsolicited if the pre-formatted text contained in the record for the first electronic message exists in the unauthorized database (step S431), for example, then the first electronic message is marked as an unsolicited electronic message (step S432). Moreover, assuming that an entry exists in the unauthorized database, the first electronic message is deleted (step S433), and ‘next message’ processing occurs (step S417 et seq.).

While searching for point-of-contact information in an unauthorized database or an authorized database is desirable for reducing the number of electronic messages which require further review, it is but one technique, and other techniques are contemplated. Other arrangements may perform the detection of unsolicited electronic messages on systems which do not have an excess of processing power or storage space. In these alternate arrangements, the step of comparing the record to the authorized database and/or the unauthorized database is omitted or combined with other steps, and the associated steps of creating and/or transmitting the databases between entities are limited or omitted, as appropriate.

If the pre-formatted text associated with the first electronic message does not exist in the unauthorized database or the authorized database, at least a subset of the plurality of electronic messages, including the second electronic message, is searched for the pre-formatted text (step S435). Specifically, at least the second electronic message, up to and including all of the messages which constitute the batch, is searched for the point-of-contact information associated with the pre-formatted text. According to one aspect, searching the subset of the plurality of electronic messages for the pre-formatted text further includes looking in the plurality of electronic messages, except for the first electronic message, for the data matching pattern recognized as the billing contact pattern found in the first electronic message.

Although a spammer may be able to manipulate the origin data in the headers of the electronic messages that they send, it is likely that the point-of-contact information for all of the electronic messages will be the same, or at least similar to, point-of-contact information found in other electronic messages of the same bulk electronic message blast. Accordingly, a blast of unsolicited electronic messages is detected by searching for pre-formatted text indicative of point-of-contact information common to more than one electronic message in the batch.

If no matches of the pre-formatted text exist in at least the second electronic message (step S436), the first electronic message is delivered (step S413), and ‘next message’ processing occurs (step S417 et seq.). No matches of the pre-formatted text indicate that a blast of electronic messages has not occurred, and that it is unlikely that the first electronic message is unsolicited.

Conversely, if a match of the pre-formatted text exists in at least the second electronic (step S436), the matched message (the second electronic message) is identified as including the pre-formatted text based upon the searching of at least the subset of the plurality of electronic messages (step S437). If the second electronic message also includes the pre-formatted text indicative of point-of-contact information, it is more likely that the first electronic message and the second electronic messages are both part of an electronic message blast, and further testing may be desirable. According to one aspect, identifying the second electronic message as including the pre-formatted text based upon the searching of at least the subset of electronic messages further includes designating the second electronic message as containing the data matching pattern recognized as the billing contact pattern based upon finding the data matching pattern in the second electronic message.

The size of the first electronic message is compared with the size of the second electronic message (step S439). Size comparisons are another way to determine whether two or more similar electronic messages are part of the same bulk, unsolicited electronic message blast. It is more likely that two messages sharing identical point-of-contact information are unsolicited electronic messages if the size of both of the messages is the same, or at least similar, to account for intentional randomization within the body of messages of an unsolicited electronic message blast. Since intentional randomization of body text is one technique applied by bulk electronic message senders to deceive conventional unsolicited electronic message filters, a predetermined threshold is defined to help in the determination of whether two electronic messages are the same.

If the size of the first electronic message is not within a predetermined threshold of the size of the second electronic message (step S441), the first electronic message is delivered (step S413), and ‘next message’ processing occurs (step S417 et seq.). The greater the difference in size of the two electronic messages, the less likely it is that the first electronic message and the second electronic messages are sent by a sophisticated spammer and are thus unsolicited. In this regard, if the size of first electronic message exceeds the size of the second electronic message plus or minus the size of the predetermined threshold, the message is indicated as not unsolicited, and is delivered as normal. In one aspect, the predetermined threshold is plus or minus two kilobytes, to account for intentional randomization inserted into the electronic message, although other predefined thresholds, such as plus or minus one byte, five bytes, ten kilobytes, five hundred kilobytes, twenty megabytes, five hundred megabytes, or twenty gigabytes may also be used. In this regard, the first electronic message is compared to the second electronic message, where flagging the first electronic message as unsolicited is based in part upon the comparison.

If the size of the first electronic message does not exceed the size of the second electronic message plus the size of the predetermined threshold, the first electronic message may be subject to additional scrutiny to determine if it is an unsolicited electronic message. Specifically, if the size of the first electronic message is within a predetermined threshold of the size of the second electronic message (step S441), the origin data from the header of the first electronic message is compared with origin data from the header of the second electronic message (step S443). If the origin data from the header of the first electronic message is the same as the origin data from the header of the second electronic message, the message is delivered (step S413), and ‘next message’ processing occurs (step S417 et seq.).

Method 400 is designed to detect unsolicited electronic messages from expert spammers using advanced blast techniques. Since such senders of unsolicited electronic messages routinely change the origin data in the header of the electronic message, all other factors being equal, it is more likely that the first electronic message is an unsolicited electronic message if the second electronic message includes different origin data. While it may be counter-intuitive to flag two unsolicited electronic messages with the same origin as legitimate, while identifying two unsolicited electronic messages with different origins as illegitimate, this determination is based upon research and experience which shows that expert spammers will almost always change the origin data of each message in a blast. These advanced spam blasts are of the type which often fool conventional unsolicited electronic message detection techniques, and thus the discrimination of messages based upon origin is particularly useful.

If the origin data from the header of the first electronic message is different from the origin data from the header of the second electronic message (step S445), additional mismatch tests are performed (step S447). Thus, the origin data from the header of the first electronic message is compared with the origin data from the header of the second electronic message, where the first electronic message is flagged as unsolicited if origin data from the header of the first electronic message is different than origin data from the header of the second electronic message.

Additional mismatch tests are performed to determine whether the first electronic message and the second electronic messages are part of the same unsolicited electronic message blast, where the greater the mismatch between the two messages, the more likely that the messages are solicited or legitimate. Mismatch tests could be simple tests, such as word counts or comparisons, or they could be complex heuristical analyses, such as an analysis of the semantics of each message, or complex analyses of word choice, patterns, and/or usage. If the additional mismatch tests indicate that the first electronic message and the second electronic message are mismatched, the first electronic message is delivered (step S413), and ‘next message’ processing occurs (step S417 et seq.). If, however, the additional mismatch tests indicate that the first electronic message and the second electronic message are not mismatched (step S451), the record is transferred from the message server (step S451), and received by the central database server (step S453). In one aspect, the message server and the central database server are the same, and thus the transfer and reception (steps S451 and S453) are performed internally to the combined server, or are omitted entirely, as appropriate.

Each of the above-described tests (steps S437 to S449) provides the advantage of reducing the number of electronic messages to be manually scrutinized. With this in mind, in certain circumstances, it may be desirable to omit, re-order, or combine certain ones of these tests, or to add additional tests which also compare a first electronic message against a second electronic message for mismatch or similarity. The number and sequence of tests used will be determined by desired system accuracy and speed, predicted number of electronic messages to be processed, and available system resources. In one high-speed system, for example, no automatic comparisons are performed at all, and every message which contains matching pre-formatted text indicative of point-of-contact information is forwarded for manual review, as is described infra.

A review of the record is performed (step S455). In one arrangement, the review is conducted by a trained reviewer, where the record is opened, a copy of the electronic message is viewed, and the reviewer uses their judgment and training to determine whether a particular electronic message is an unsolicited electronic message. In another arrangement, the review is conducted automatically. If the review determines that the first electronic message is not a bulk message (step S457), a deliver message is transmitted from the central database server (step S459), and is received by the message server (step S461).

A decision is made whether to add the point-of-contact information indicated by the pre-formatted text to an authorized database (step S463). A reviewer might decide, for instance, that every message with the pre-formatted text should always be delivered without being subjected to further scrutiny, such as the scrutiny described in steps S435 et seq. If the point-of-contact information is to be added, it is added to the authorized database on the central database server (step S465), and a decision is made whether to update the authorized database on the message server (step S467). Since an entry in the authorized database could potentially allow an electronic message under scrutiny to bypass all other screening, the decision to add specific point-of-contact information to an authorized database is not one to be taken lightly. An entry indicative of a reliable and trustworthy entity, such as a government agency, a school, a charity or a law firm, would be appropriate example entries for the authorized database. If the authorized database does not yet exist at this point, an authorized database, such as a SQL database, is created and the record is added to the new database as a first record.

To assist in the decision process, a trained reviewer is presented with the electronic message or a copy of the electronic message on a display. In one aspect, the pre-formatted text indicative of point-of-contact information is highlighted on the display to allow the reviewer to make a quicker response. The reviewer reads the electronic message, and makes a determination of whether the electronic message is unsolicited, or legitimate. By selecting a control on their workstation, the reviewer is able to provide feedback in real-time or non-real time of their determination, and the electronic message is no longer displayed. In another aspect, an additional user interface displays the point-of-contact information, and allows the reviewer to select whether the individual information should be added to the authorized database or the unauthorized database, or ignored. A further user interface controls the updating of databases on individual message servers, and allows, for example, a reviewer to manually update message server databases. When processing of one electronic message is complete, a next message in a queue is displayed for further processing.

If the point-of-contact information is not to be added to the authorized database (step S463), the determination of whether to update the authorized database on the message server occurs (step S467). It would be appropriate to not add point-of-contact information to the authorized database, for example, where the reviewer determines that an individual message is not unsolicited, but where future messages with similar point-of-contact information should not be allowed to bypass all further scrutiny.

Since the central database server includes a master copy of the authorized database and the unauthorized database, it is appropriate to update each copy of the authorized database and the unauthorized database stored on each serviced mail server. According to one aspect, the update occurs on a predetermined basis, such as after a fixed number of reviews, after a certain period of time has elapsed, or after a certain number of new entries have been added. For instance, the update could occur after every ten reviews, once per hour, or after each new entry has been added to a database.

If the authorized database on the message server is to be updated (step S467), the authorized database on the central database server, or individual records to be updated from the authorized database on the central database server, is transmitted to the message server (step S469), the authorized database, or individual records from the authorized database, is received on the message server from the central database server (step S471), and the existing authorized database at the message server is updated or replaced (step S473). In any regard, once the deliver message is received by the message server (step S461), the first electronic message is delivered (step S413), and ‘next message’ processing occurs (step S417 et seq.). In one aspect, the message server and the central database server are the same, and thus the transfer and reception (steps S469 and S471) are performed internally to the combined server, or are omitted entirely, as appropriate.

If the review determines that the first electronic message is a bulk message (step S457), a delete message is transmitted from the central database server (step S475), and is received by the message server (step S477). In this regard, the first electronic message is flagged as unsolicited based upon the identifying of the second electronic message (step S437). Upon receipt of the delete message, the first electronic message, the second electronic message and/or any other message sharing the same point-of-contact information are deleted from the batch.

A decision is made whether to add the point-of-contact information indicated by the pre-formatted text to an unauthorized database (step S479). If the point-of-contact information is to be added (step S479), it is added to the unauthorized database on the central database server (step S481), and a decision is made whether to update the unauthorized database on the message server (step S483). If the point-of-contact information is not to be added to the unauthorized database (step S479), the determination of whether to update the unauthorized database on the message server occurs (step S483).

According to one aspect, once point-of-contact information has been added to the unauthorized database, a DNS lookup is performed to determine the host of each sending message server, and a message is automatically sent to the host to inform them of the electronic messaging abuse. In another aspect, the central database server only maintains an authorized database or an unauthorized database but not both, or neither an authorized database nor an unauthorized database are maintained. Similarly, multiple authorized databases or unauthorized databases may also be maintained, for example, where records are maintained in a database based upon trustworthiness of the sender based upon the point-of-contact information.

If the unauthorized database on the message server is to be updated (step S483), the unauthorized database, or individual updated records, on the central database server is transmitted to the message server (step S485), the unauthorized database, or updated records, is received on the message server from the central database server (step S487), and the existing unauthorized database at the message server is updated or replaced (step S489). In any regard, once the delete message is received by the message server (step S477), the first electronic message is delivered (step S415), and ‘next message’ processing occurs (step S417 et seq.). In one aspect, the message server and the central database server are the same, and thus the transfer and reception (steps S485 and S487) are performed internally to the combined server, or are omitted entirely, as appropriate.

According to an additional arrangement, a computer program product, tangibly stored on a computer-readable medium, is provided for detecting an unsolicited electronic message. The product includes instructions for permitting a computer to perform a receiving step for receiving a plurality of electronic messages, including a first electronic message and a second electronic message, each electronic message including a header portion and a body portion, and a first searching step for searching the body portion of the first electronic message for pre-formatted text indicative of point-of-contact information. The product also includes instructions for permitting a computer to perform a second searching step for searching at least a subset of the plurality of electronic messages, the subset including the second electronic message, for the pre-formatted text, an identifying step for identifying the second electronic message as including the pre-formatted text based upon the searching of at least the subset of electronic messages, and a flagging step for flagging the first electronic message as unsolicited based at least upon the identifying of the second electronic message.

It is understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components.

The arrangements have been described with particular illustrative embodiments. It is to be understood that the concepts and implementations are not however limited to the above-described embodiments and that various changes and modifications may be made.

What is claimed is:

1. A method for detecting an unsolicited electronic message, comprising the steps of:
receiving a plurality of electronic messages, including a first electronic message and a second electronic message, each electronic message including a header portion and a body portion;
tokenizing the body portion of the first electronic message;
searching the body portion of the first electronic message for pre-formatted text indicative of point-of-contact information;
searching at least a subset of the plurality of electronic messages, the subset including the second electronic message, for the pre-formatted text at the message server;
identifying the second electronic message as including the pre-formatted text based upon the searching of at least the subset of the electronic messages;
comparing the first electronic message to the second electronic message;
comparing the pre-formatted text to an unauthorized database;
subjecting the first electronic message to a manual review;
generating a delete signal and the unauthorized database based upon the manual review; and
flagging the first electronic message as unsolicited based at least upon the identifying of the second electronic message, the comparing of the first electronic message to the second electronic message, the comparing of the pre-formatted text to the unauthorized database, and/or the generating of the delete signal.

2. A method for detecting an unsolicited electronic message, comprising the steps of:
receiving a plurality of electronic messages, including a first electronic message and a second electronic message, each electronic message including a header portion and a body portion;
searching the body portion of the first electronic message for pre-formatted text indicative of point-of-contact information;
searching at least a subset of the plurality of electronic messages, the subset including the second electronic message, for the pre-formatted text;
identifying the second electronic message as including the pre-formatted text based upon the searching of at least the subset of the plurality of electronic messages; and
flagging the first electronic message as unsolicited based at least upon the identifying of the second electronic message.

3. The method according to claim 2, wherein searching the body portion of the first electronic message for pre-formatted text indicative of point-of-contact information further comprises looking for a data matching pattern recognized as billing contact pattern.

4. The method according to claim 3, wherein searching at least the subset of the plurality of electronic messages for the pre-formatted text further comprises looking in the plurality of electronic messages, except for the first electronic message, for the data matching pattern recognized as the billing contact pattern found in the first electronic message.

5. The method according to claim 4, wherein identifying the second electronic message as including the pre-formatted text based upon the searching of at least the subset of electronic messages further comprises designating the second electronic message as containing the data matching pattern recognized as the billing contact pattern based upon finding the data matching pattern in the second electronic message.

6. The method according to claim 2, further comprising the step of comparing the first electronic message to the second electronic message, wherein flagging the first electronic message as unsolicited is also based upon the comparing of the first electronic message to the second electronic message.

7. The method according to claim 6,
wherein comparing the first electronic message and the second electronic message further comprises comparing a size of the first electronic message with a size of the second electronic message, and
wherein the first electronic message is flagged as unsolicited if the size of the first electronic message is within a predetermined threshold of the size of the second electronic message.

8. The method according to claim 6,
wherein comparing the first electronic message and the second electronic message further comprises comparing origin data from the header of the first electronic message with origin data from the header of the second electronic message, and
wherein the first electronic message is flagged as unsolicited if origin data from the header of the first electronic message is different than origin data from the header of the second electronic message.

9. The method according to claim 2, further comprising the step of subjecting the first electronic message to a review, wherein flagging the first electronic message as unsolicited is also based upon the subjecting of the first electronic message to the review.

10. The method according to claim 9, wherein the review is a manual review.

11. The method according to claim 9, wherein the review is an automated review.

12. The method according to claim 9,
wherein subjecting the first electronic message to the review further comprises comparing the pre-formatted text to an authorized database,
wherein the electronic message is flagged as unsolicited if the pre-formatted text does not exist in the authorized database.

13. The method according to claim 9,
wherein subjecting the first electronic message to the review further comprises comparing the pre-formatted text to an unauthorized database,
wherein the electronic message is flagged as unsolicited if the pre-formatted text exists in the unauthorized database.

14. The method according to claim 2, wherein the first electronic message is an electronic mail message, a text message, or an instant message.

15. The method according to claim 2, wherein the pre-formatted text is a telephone number, an e-mail address, a uniform resource locator, an instant message address, a mailing address, or a stock symbol.

16. The method according to claim 2, further comprising the step of tokenizing the body portion of the first electronic message.

17. The method according to claim 2, further comprising the step of deleting the flagged first electronic message.

18. The method according to claim 2, wherein identifying the second electronic message is based upon the pre-formatted text existing in the body of the second electronic message.

19. A device for detecting an unsolicited electronic message, comprising:
a receiver module configured to receive a plurality of electronic messages, including a first electronic message and a second electronic message, each electronic message including a header portion and a body portion;
a search module configured to search the body portion of the first electronic message for pre-formatted text indicative of point-of-contact information, search at least a subset of the plurality of electronic messages, the subset including the second electronic message, for the pre-formatted text, and further configured to identify the second electronic message as including the pre-formatted text based upon the searching of at least the subset of the plurality of messages; and
an indicator module configured to flag the first electronic message as unsolicited based at least upon the identifying of the second electronic message.

20. The device according to claim 19, further comprising a comparison module configured to compare the first electronic message to the second electronic message,
wherein the indicator module is configured to flag the first electronic message as unsolicited also based upon the comparing of the first electronic message to the second electronic message.

21. The device according to claim 20,
wherein the comparison module compares a size of the first electronic message with a size of the second electronic message, and
wherein the indicator module is configured to flag the first electronic message as unsolicited if the size of the first electronic message is within a predetermined threshold of the size of the second electronic message.

22. The device according to claim 20,
wherein the comparison module compares origin data from the header of the first electronic message with origin data from the header of the second electronic message, and
wherein the indicator module is configured to flag the first electronic message as unsolicited if origin data from the header of the first electronic message is different than origin data from the header of the second electronic message.

23. The device according to claim 19, further comprising a review module configured to subject the first electronic message to a review,
wherein the indicator module is configured to flag the first electronic message as unsolicited also based upon the subjecting of the first electronic message to the review.

24. The device according to claim 23, further comprising an authorized database,
wherein the review module is configured to compare the pre-formatted text to the authorized database, and
wherein the indicator module is configured to flag the electronic message as unsolicited if the pre-formatted text does not exist in the authorized database.

25. The device according to claim 19, further comprising an unauthorized database,
wherein the review module is configured to compare the pre-formatted text to the unauthorized database, and
wherein the indicator module is configured to flag the electronic message as unsolicited if the pre-formatted text exists in the unauthorized database.

26. The device according to claim 19, wherein the first electronic message is an electronic mail message, a text message, or an instant message.

27. The device according to claim 19, wherein the pre-formatted text is a telephone number, an e-mail address, a uniform resource locator, an instant message address, a mailing address, or a stock symbol.

28. The device according to claim 19, further comprising a tokenizer module configured to tokenize the body portion of the first electronic message.

29. The device according to claim 19, wherein the indicator module is further configured to deleting the flagged first electronic message.

30. The device according to claim 19, wherein the search module identifies the second electronic message as including the pre-formatted text based upon finding the pre-formatted text in the body of the second electronic message.

31. A system for detecting an unsolicited electronic message, comprising:
a central database server, further comprising:
a central database receiver module configured to receive a first electronic message,
a manual review module configured to manually review the first electronic message,
a central database indicator module configured to generate the delete signal and an unauthorized database based upon the manual review of the first electronic message, and
a central database transmitter module configured to transmit the delete signal and the unauthorized database; and
a message server, further comprising:
a message server receiver module configured to receive the unauthorized database, the delete signal, and a plurality of electronic messages, including the first electronic message and a second electronic message, each electronic message including a header portion and a body portion,
a tokenizer module configured to tokenize the body portion of the first electronic message,
a search module configured to search the body portion of the first electronic message for pre-formatted text indicative of point-of-contact information, search at least a subset of the plurality of electronic messages, the subset including the second electronic message, for the pre-formatted text, and further configured to identify the second electronic message as including the pre-formatted text based upon the searching of at least the subset of the plurality of electronic messages and finding the pre-formatted text in the body of the second electronic message,
a comparison module configured to compare the first electronic message to the second electronic message,
an automated review module configured compare the pre-formatted text to the unauthorized database,
a message server indicator module configured to flag the first electronic message as unsolicited based at least upon the identifying of the second electronic message, upon the comparing of the first electronic message to the second electronic message, upon the comparing the pre-formatted text to the unauthorized database, and/or upon receiving the delete signal, and
a message server transmitter module configured to transmit the first electronic message to said central database server.

32. A computer program product, tangibly stored on a computer-readable medium, for detecting an unsolicited electronic message, the product comprising instructions for permitting a computer to perform:
a receiving step for receiving a plurality of electronic messages, including a first electronic message and a second electronic message, each electronic message including a header portion and a body portion;
a first searching step for searching the body portion of the first electronic message for pre-formatted text indicative of point-of-contact information;
a second searching step for searching at least a subset of the plurality of electronic messages, the subset including the second electronic message, for the pre-formatted text;
an identifying step for identifying the second electronic message as including the pre-formatted text based upon the searching of at least the subset of the plurality of electronic messages; and
a flagging step for flagging the first electronic message as unsolicited based at least upon the identifying of the second electronic message.

33. The computer program product according to claim 32, the product further comprising instructions for permitting a computer to perform a comparing step for comparing the first electronic message to the second electronic message, wherein flagging the first electronic message as unsolicited is also based upon the comparing of the first electronic message to the second electronic message.

34. The computer program product according to claim 32, the product further comprising instructions for permitting a computer to perform a subjecting step for subjecting the first electronic message to a review, wherein flagging the first electronic message as unsolicited is also based upon the subjecting of the first electronic message to the review.

35. The computer program product according to claim 32, the product further comprising instructions for permitting a computer to perform a tokenizing step for tokenizing the body portion of the first electronic message.

36. The computer program product according to claim 32, the product further comprising instructions for permitting a computer to perform a deleting step for deleting the flagged first electronic message.
